(19) United States
(12) Patent Application Publication
(10) Pub. No.: US 2016/0011362 A1
(43) Pub. Date: Jan. 14, 2016

(54) TRAFFIC DIRECTION LIGHTS

(71) Applicant: CHIEN-CHUNG JENG, PINGTUNG (TW)

(72) Inventor: CHIEN-CHUNG JENG, PINGTUNG (TW)

(21) Appl. No.: 14/711,837

(22) Filed: May 14, 2015

(30) Foreign Application Priority Data
Jul. 11, 2014 (TW) 103124937

(51) Int. Cl. F21V 8/00; F21S 8/10

(52) U.S. Cl. CPC G02B 6/0068; G02B 6/0055; G02B 6/0051; G02B 6/0046; G02B 6/0073; F21S 48/2243; F21S 48/2281; F21S 48/2268; F21Y 2103/003

(57) ABSTRACT

The present invention provides a kind of traffic direction light consisting of a backlight module and several light sources where the backlight module comprises a light guide plate with one side provided with multiple light-reflection points, a reflective sheet with the characteristics of the reflected light ray and applied onto the one side of the light guide plate provided with the light-reflection points, and a diffusion sheet applied onto the other side of the light guide plate with the characteristics to distribute the light rays uniformly; and the light sources are able to cast at least one kind of light ray of different colors and arranged at least at one end of the light guide plate so that the light ray can be cast out through the backlight module.

### BACKGROUND OF INVENTION

1. Field of the Invention

The present invention relates generally to a kind of traffic signal light, and more particularly to a kind of traffic direction light which can display several kinds of uniform multicolor lights with a single light.

2. Description of Related Art

The conventional traffic signal (such as the traffic light) set at the road intersection uses the direction of the light signals in different colors to provide the walking and driving rules for the pedestrians and vehicle drivers, which basically consists of the lampshades of several different colors (such as red, yellow and green) as well as multiple LEDs and other components installed in the shade with each LED arranged by following the rule of orthophototropism (with the light-emitting direction facing the lampshade) inside the lampshade. Therefore, the LEDs in different lampshades can give out the light SEQUENTIALLY at the predetermined times under the system control so that the traffic signal can produce the light signals of different colors.

Since the aforementioned conventional traffic signal contains several lampshades of different colors and multiple LEDs of orthophototropism arranged in each lampshade, therefore, the overall volume is not only not small, and the number of LEDs needed is big. Moreover, a small number of LEDs or their electric circuits would be damaged after a period of time of usage, causing the light of some blocks on the direction panel missing. Thus, although the construction has been used for many years, there are places to be improved obviously.

Second, the rear of a conventional vehicle consists of lights with the directing effect, typically including the light units like the taillight, brake light, reversing light and steering light, which are able to give out light rays of different colors (using the lampshades or light bulbs of different colors) individually. The constructions of the lampshades and light bulbs are like the traffic signals except that the number of light bulbs is small. If the overall volume could be reduced, it will be helpful to the exterior design of the vehicle and the expansion of the luggage space.

### SUMMARY OF THE INVENTION

The main purpose of the present invention is to provide a kind of traffic direction light characteristic of compact structure, small volume and small thickness that is able to display the uniform and multicolor traffic direction light simply with a single light. It is learned that the directing effect, efficacy and practical value of the lights of the red light of the conventional road traffic light signal and the rear light assembly of the vehicle are both very good.

Thus, to achieve the aforementioned purpose, the present invention provides a kind of traffic direction light which consists of a backlight module arranged in the bottom shell, comprising a light guide plate with one side provided with multiple light-reflection points, a reflective sheet with the characteristics of the reflected light ray and applied onto the one side of the light guide plate provided with the light-reflection points and a diffusion sheet applied onto the other side of the light guide plate correspondingly with the characteristics to distribute the light rays uniformly; and several light sources able to cast at least one kind of light ray of different colors and arranged at least at one end of the light guide plate so that the light ray can be cast out through the backlight module.

### BRIEF DESCRIPTION OF THE DRAWINGS

FIG. 1 is the schematic diagram of the front of the better implementation example of the present invention. FIG. 2 is the schematic diagram of the side of the better implementation example of the present invention.

FIG. 3 is the schematic diagram of the light ray casting path of the better implementation example of the present invention.

FIG. 4 is the schematic diagram of another better implementation example of the present invention.

FIG. 5 is the schematic diagram of another better implementation example of the present invention.

### DETAILED DESCRIPTION OF THE INVENTION

The detailed explanation is further provided as follows by taking the better implementation example of the present invention for example and using the diagrams:

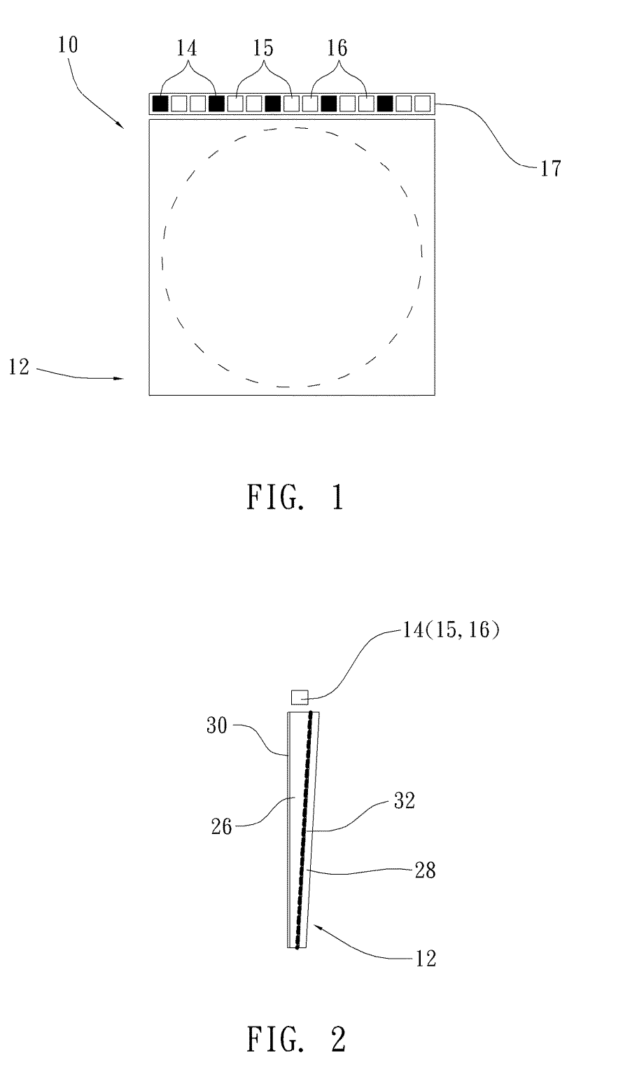

Referring to FIGS. 1 and 2 for the traffic direction light 10, a better implementation example of the present invention, which consists of a backlight module 12 and several light sources 14, 15 and 16.

The backlight module 12, like the backlight module applied on the panel display conventionally, can be arranged within a lampshade (not shown in diagram) and is composed of a light guide plate 26, a reflective sheet 28 and a diffusion sheet 30 affixed together. The light guide plate 26 is a wedge-shaped plate with one thick end and one thin end. Certainly, it can be replaced by a conventional flat or curved light guide plate. It is made of the materials like PMMA by way of die-casting or injection. Its one side (the inclined side) is provided with multiple light-reflection points 32 (or known as the diffusion points), which are printed with the ink not absorbing the light in different sizes, shapes or density used to destroy the total reflection of light ray and guide the light rays to the front side of the light guide plate 26. The reflective sheet 28 applied onto the one side of the light guide plate 26 provided with the light-reflection points 32 is used to reflect the lights leaking out of the light guide plate 26 back to the light guide plate 26. The diffusion sheet 30 applied onto the other side of the light guide plate 26 is made of poly ester or poly carbonate and has the characteristics to distribute the light rays uniformly.

The light sources 14, 15 and 16 are light-emitting diodes able to cast three different colors of light rays and arranged in an alternating manner on a circuit substrate 17 at one end (the thick end) of the light guide plate 26, which can cast the light rays into the light guide plate 26 and cast out them through the light guide plate 26.

Thus, the traffic direction light 10 can cast out the uniform light rays in different colors by driving the different light sources 14, 15 and 16 to achieve the traffic direction effect and used as the traffic signal or the light assembly at the rear of the vehicle (including the brake, steering and reversing lights) with the operation mode, characteristics and efficacy shown as follows:

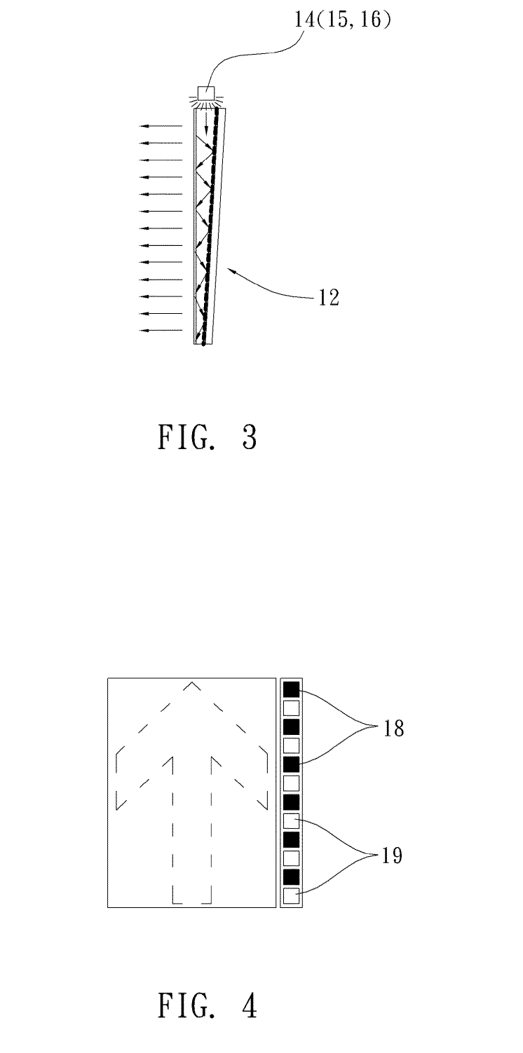

In the case that the traffic direction light 10 is used as the traffic signal light, connect the circuit substrate 17 electrically to the traffic light signal control system and adopt the light sources 14, 15 and 16 able to cast three different colors (red, yellow and green) of light rays. The light sources 14, 15 and 16 of said different colors of light rays are arranged in an alternating manner respectively (adjusting the number according to the brightness demand) as shown in FIGS. 1 and 3.

Thus, regardless if the traffic signal is indicating the red light, yellow light or green light, the traffic direction light 10 can utilize the inside backlight module 14 to reflect out the light rays of the light sources 14, 15 and 16 uniformly to further produce the traffic direction effect, just like the effect produced by the lamp shades of three different colors (multiple LED lights are arranged at the front side internally) of the conventional traffic signal.

That is, the traffic direction light 10 of the present invention can produce the lights in the three different colors of the red, yellow and green by driving the light sources 14, 15 and 16 of the lights in different colors to achieve the traffic direction light signal effect of the red light, yellow light or green light. Compared to the conventional road traffic light signals, the present invention is able to achieve the traffic direction light signal effect of the red light, yellow light and green light of the conventional traffic signal with the compact structure (single light and a relatively small number of LED lights). Moreover, the overall volume is smaller and the number of LED lights used can be substantially reduced.

In particular, the light rays of the light sources 14, 15 and 16 are cast out uniformly through the backlight module 14. When a LED light is damaged, the overall light intensity would only be slightly dimmed and the situation of the light of some block or corner on the traffic signal direction panel missing would not occur.

Certainly, the light sources can also only include the light-emitting diodes able to cast the light rays of two different kinds of colors, such as the light sources 18 and 19 in FIG. 4. Therefore, it can be used for the traffic signal only having the light signals in two kinds of colors.

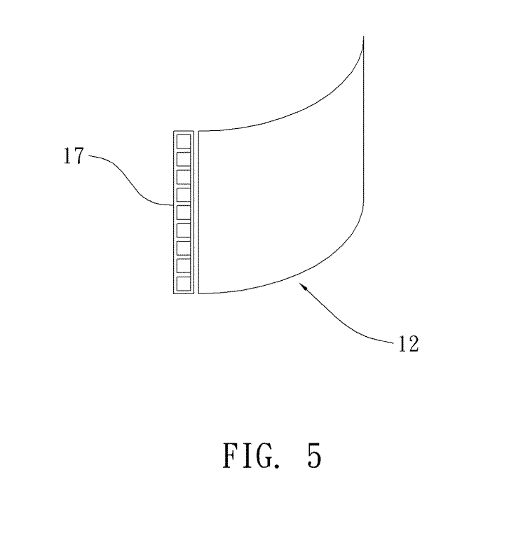

Secondly, the traffic direction light of the present invention can be used as the light assembly at the rear of the vehicle based on the requirements and the characteristics of casting uniform multicolor lights under control, as shown in FIG. 5. In this case, the backlight module 12 is in a curved shape fit for the radian of the rear corners of the vehicle. The circuit substrate 17 is a vehicle computer electrically connected to the vehicle and used to cast out the lights of different colors by the traffic direction light 10 under the vehicle driving states, such as braking, steering or reversing, to direct or remind the pedestrians or vehicles in the rear, achieving the efficacy of the rear light assembly of the conventional vehicle. Moreover, it has a smaller volume and thinner thickness that can increase the usage elasticity of the vehicle shell and the exterior design flexibility.

In summary, the traffic direction light provided by the present invention can achieve the traffic direction effect by displaying the uniform multicolor lights with a single light and replace the conventional road traffic signal or the rear lamp assembly of the vehicle. Each kind of color light needs to occupy a block of structure and the number of lights can be substantially decreased. Also, the overall volume and the thickness can be significantly reduced. The efficacy is very good with very practical and economic values. Therefore, the present invention complies with the provisions of an invention patent and the application is filed according to law.

What is claimed is:

1. A kind of traffic direction light used to achieve the traffic direction effect of displaying the uniform multicolor lights with a single light, comprising:
a backlight module, further comprising a light guide plate with one side provided with multiple light-reflection points, a reflective sheet with the characteristics of the reflected light ray and applied onto the one side of the light guide plate provided with the light-reflection points and a diffusion sheet applied onto the other side of the light guide plate with the characteristics to distribute the light rays uniformly; and
several light sources, arranged at least at one end of the light guide plate and able to cast at least one kind of light ray of different color and allow the light ray to be cast out through the backlight module.

2. The structure defined in claim 1, wherein said reflective sheet is made of the material capable of light ray reflection and used to reflect the lights leaking out of the light guide plate back to the light guide plate.

3. The structure defined in claim 1, wherein said light guide plate is a wedge-shaped plate with one thick end and one thin end and the light sources arranged at the thick end of the light guide plate.

4. The structure defined in claim 1, wherein said light guide plate is in a curved shape with the light sources arranged at one end of the light guide plate.

5. The structure defined in claim 3, wherein said light-reflection points are made of materials having a high reflectivity and not absorbing the lights.

6. The structure defined in claim 4, wherein said light-reflection points are made of materials having a high reflectivity and not absorbing the lights.

7. The structure defined in claim 3, wherein a circuit substrate is contained with the light sources arranged on the circuit substrate.

8. The structure defined in claim 4, wherein a circuit substrate is contained with the light sources arranged on the circuit substrate.

9. The structure defined in claim 7, wherein said light sources able to cast three different colors of light rays are provided and the light sources of said different colors of light rays are arranged in an alternating manner at one end of the light guide plate.

10. The structure defined in claim 8, wherein said light sources able to cast three different colors of light rays are provided and the light sources of said different colors of light rays are arranged in an alternating manner at one end of the light guide plate.

11. The structure defined in claim 7, wherein said light sources able to cast two different colors of light rays are provided and the light sources of said different colors of light rays are arranged in an alternating manner at one end of the light guide plate.

12. The structure defined in claim 8, wherein said light sources able to cast two different colors of light rays are provided and the light sources of said different colors of light rays are arranged in an alternating manner at one end of the light guide plate.

13. The structure defined in claim 11, wherein said light sources are the light-emitting diodes.

14. The structure defined in claim 12, wherein said light sources are the light-emitting diodes.

15. The structure defined in claim 9, it can be used as the traffic signal or the light assembly at the rear of the vehicle including the brake, steering and reversing lights.

16. The structure defined in claim 10, it can be used as the traffic signal or the light assembly at the rear of the vehicle including the brake, steering and reversing lights.
